(19) United States
(12) Patent Application Publication
(10) Pub. No.: US 2017/0126605 A1
(43) Pub. Date: May 4, 2017

(54) IDENTIFYING AND MERGING DUPLICATE MESSAGES

(71) Applicant: International Business Machines Corporation, Armonk, NY (US)

(72) Inventors: Lisa Seacat DeLuca, Baltimore, MD (US); Vanessa V. Michelini, Boca Raton, FL (US)

(21) Appl. No.: 14/929,507

(22) Filed: Nov. 2, 2015

(51) Int. Cl. H04L 12/58; G06F 17/30; G06F 17/27

(52) U.S. Cl. CPC H04L 51/16; H04L 51/32; G06F 17/2705; G06F 17/30675; G06F 17/30684

(57) ABSTRACT

Messages from a set of social data sources may be handled by merging matching messages into a same thread. In response to the detection of a new message, content data about the message and from the message may be parsed. The content data of the new message can be compared with content data from each thread in a plurality of existing threads. The system can determine that the content of the new message matches the content of one of the threads, and the new message can be merged with the thread.

### BACKGROUND

The present disclosure relates to message handling, and more specifically, to message organization. Users may receive messages from a variety of social media sources. Social media may be computer-mediated tools that allow people to create, share, or exchange information, ideas, and pictures or videos in virtual communities and networks. Social media may depend on mobile and web-based technologies to create highly interactive platforms through which individuals and communities share, co-create, discuss, and modify user-generated content.

Messages may also be sent and received via electronic mail, or “email”. Web-based email may allow users to log into an email account by using any compatible web browser to send and receive email. For email using a web-based client, the mail or messages themselves need not be downloaded to the client, and thus an Internet connection may be involved in accessing email.

### SUMMARY

Embodiments of the present disclosure may be directed toward a method for handling messages from a set of social data sources. A new message may be detected from the set of social data sources, and content data may be parsed from the new message in response. The content data may be relevant to content of the new message. The content data of the new message may be compared with content data of each thread in a plurality of threads. Each of these threads may comprise a message or messages. From the comparing of the content data, the content of the new message may be determined to be the same as the content of a particular thread. The new message can then be merged with the particular thread.

Embodiments of the present disclosure may be directed toward a system for handling messages from a set of social data sources. The system may comprise a computing device with a computer readable medium with program instructions stored thereon. The system may also comprise one or more processors configured to execute the program instructions to perform a method. The method may comprise detecting a new message from the set of social data sources. The content data can be parsed from the new message, with the content data being data relevant to the content of the new message. The content data of the new message can be compared with the content data of each of the plurality of threads. Each thread in the plurality of threads can comprise one or more messages. Content of the new message may be determined to be the same as the content of a particular thread in the plurality of threads. This determination may be based on the comparing the content data. The new message may be merged with the particular thread in the plurality of threads.

Embodiments of the present disclosure may be directed toward a computer program product for handling messages from a set of social data sources. The computer program product may comprise a computer readable storage medium with program instructions embodied therewith. The computer readable storage medium is not a transitory signal per se, and the program instructions may be executable by a computer processor to cause the processor to perform a method. The method may comprise detecting a new message from the set of social data sources. The content data can be parsed from the new message, with the content data being data relevant to the content of the new message. The content data of the new message can be compared with the content data of each of the plurality of threads. Each thread in the plurality of threads can comprise one or more messages. Content of the new message may be determined to be the same as the content of a particular thread in the plurality of threads. This determination may be based on the comparing the content data. The new message may be merged with the particular thread in the plurality of threads.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a system for handling and merging messages, based on content, according to embodiments.

FIG. 2 depicts a flow diagram of a method for handling incoming messages, based on content, according to embodiments.

FIG. 3 depicts a block diagram of an example natural language processing system configured to parse content data from messages, according to embodiments.

FIG. 4 depicts representative components of an example computer system that may be used according to embodiments of the message handling system or elements thereof.

FIG. 5 depicts a flow diagram of a method for merging and sorting messages, according to embodiments.

FIG. 6 depicts an example user interface for displaying messages, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to data delivery, more particular aspects relate to message delivery based on content. While the present disclosure is not necessarily limited to such applications, various aspects of the disclosure may be appreciated through a discussion of various examples using this context.

On social media, email, and other messaging platforms, multiple messages may be received that contain essentially identical content. For any number of reasons, these messages with matching content may be received and presented to the user as distinct messages.

In embodiments, messages with matching content may be identified based on content and merged when presented to the user. A new message may be detected from a social data source or set of social data sources. For example, an email server could receive a new email message, a new TWEET could be received for a particular user account's feed, or another type of message from a social media or digital source could be received. The system could parse content data from the new message. In some embodiments, a new message may be parsed and certain natural language processing techniques may be used to identify entities, phrases, or other subject matter in the new message that can be used to determine the content of the message. Content of messages in existing threads may be parsed upon receipt as well, to identify words and phrases as they pertain to the content of the message.

The content data of the new message can then be compared with the content data of each thread in the plurality of threads. Based on the comparing, the system may determine that the content of the new message is or is not the same as the content of a particular thread in the plurality of threads.

In determining that the content of the new message matches the content of a particular thread in the plurality of threads, a sameness value may be compared with a threshold value. In embodiments, the sameness value may be calculated during the previous step of comparing the content data of the new message with the content data of the threads, and there may be varying levels of similarity required to categorize a message as the “same” as one or more other message.

If the sameness value exceeds the threshold value, then the content of the messages may be determined to be the same. Thus, the content data of the message may or may not be identical to the content data of the thread to which it is determined to be the same, as the comparison of similar content data may result in a sameness value that exceeds the threshold, despite differences existing in the content data of the message and the particular thread.

In embodiments, a sameness value may be calculated using an algorithm that includes one or more factors, which may be weighted according to user preference. Stated another way, a sameness value algorithm may be designed to output a sameness value based on a certain level of similarity across a particular number of categories (e.g., subject, sender, tone, images, etc.). For example, in some embodiments, one or more variables may be used in the algorithm used to determine the sameness value.

For example, for a user who receives emails primarily from a direct manager and his team members, the user may set an algorithm to decrease the weight given to the origin or “from” category, while increasing the weight of a category associated with subject matter in calculating a sameness value. In this way, the sameness value may be more likely to identify as the same a set of emails that were all forwarded from the same original source (but from different coworkers), while being less likely to identify as the same a set of emails all coming from a particular team member, where the content was associated with a same project.

Once the message has been identified as the same as a particular thread, the message may be merged with the thread. If a matching thread is not found for the particular message, the system may create a new thread for the message, with which future messages may be compared and, if identified as the same, merged.

In some embodiments, the system may further rank the messages in a particular thread. For example, the system could rank the messages by comparing each message in a particular thread with a metric that may be more precise or narrow than the threshold (e.g. a similarity threshold) used in the initial determination. Thus, differences in the messages that were previous identified as “matching” or “the same” could be identified and used in the comparison. The messages could then be ranked, for example, based on popularity of a particular message, importance of the user, frequency of interactions with a particular user, or another criteria that may be included in the system settings. For example, the messages could be ranked from the most to the least popular, and popularity could be defined based on the number of times a particular message appears in exactly the same format in the same thread. Popularity could also be defined based on a social media-based definition of popularity, for example a number of LIKES, RETWEETS, or users reached by the particular message. Similarly, the importance of the user could be defined based on the importance of the sender generally, as determined by a similar popularity threshold. It could also be defined based on the importance of the sender (user) to the particular recipient, based on, for example, relationship, corporate hierarchy, or the recipient's past interactions with the particular sender.

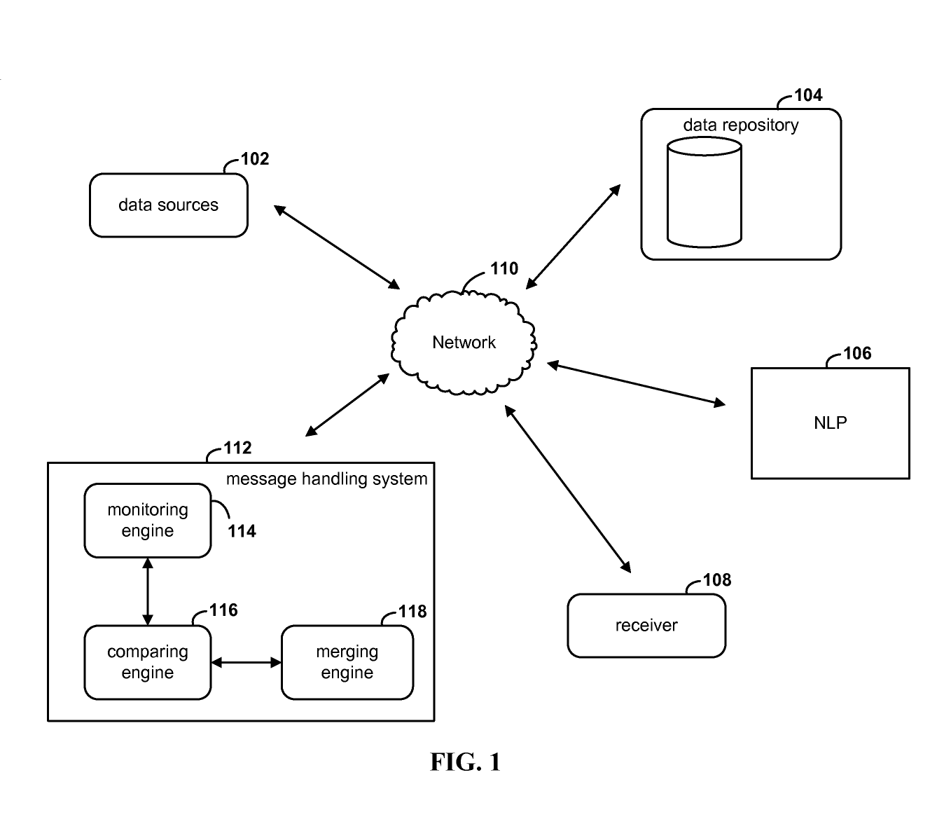

FIG. 1 depicts a system for handling and merging messages, based on content, according to embodiments. FIG. 1 may be carried out on various processing circuits, and may include the engines described herein, or more or fewer engines than those described. Data sources 102 may provide data in the form of messages. Data sources 102 may include email web servers; social media feeds like TWITTER, FACEBOOK, or other social media platforms; a company's internal community pages; or other data sources. In some embodiments, the receipt of a message from data sources 102 may initiate the system to handle the message as described herein.

In embodiments, data, including messages from data sources 102, may be sent and received over one or more networks, for example network 110. The networks can include, but are not limited to, local area networks, point-to-point communications, wide area networks, the global Internet, and combinations thereof. A data repository 104 may be used by the system to store content data, identifying and relational data, and thread data for a message handling system 112. In some embodiments, the data repository 104 may be a part of the message handling system 112, or the data repository 104 may be a separate entity.

A natural language processing (NLP) system 106 may parse data from messages in order to determine content including subject, tone, sender, recipients, message body, graphics, or other data. A receiver 108 may be a receiving device, account, server, or other entity able to receive a message or messages. As used herein, unless otherwise specifically noted, “account” refers generally to an account associated with an email account, internal profile, social media account, or other account which may be specific to a particular user, group, company, or other person or entity.

In embodiments, the message handling system 112 may comprise a monitoring engine 114, a comparing engine 116, and a merging engine 118. The message handling system 112 may comprise more or fewer than these engines and may be organized in another manner consistent with the disclosure. In the example depicted in FIG. 1, message handling system 112 may comprise a monitoring engine 114 which can monitor a particular account or inbox and detect an incoming new message received from one of the data sources 102 over the network 110. Upon the monitoring engine 114 detecting the new message, it can send data from the new message to the NLP system 106, for parsing of content. The NLP system 106 can process the message data in a manner described herein or according to other methods suitable to natural language processing, and send the message over the network 110 to the message handling system 112. In some embodiments, the NLP 106 may be a component of the message handling system 112, and thus the message transfer and receipt could each occur within the message handling system 112 itself.

Once the NLP system has parsed the message, the comparing engine 116 of the message handling system 112 can then compare the newly received message with existing messages assigned to the particular account. The comparing engine 116 can access data in the data repository 104 that may contain past parsing, comparing, or other data related to individual messages or threads of messages. The comparing engine 116 can compare the parsed data of the new message with the existing data for current threads associated with the account. Based on the comparing, the message handling system 112 can determine, using a sameness value, that the parsed content of the new message is the same as the existing content of a current thread. The sameness value can be calculated using an algorithm that accounts for one or more categories of message content data including, for example, subject data about the subject of the message; origin data about the origin of the message, including the sender and originating location; image data about one or more images contained within the message; and tone data about the tone Once the determination is made, the merging engine 118 can then merge the new message with an existing thread. If the determining results in an indication that the content of the new message is not the same as the content of any of the current threads, the message handling system 112 may create a new thread and assign the message to the new thread. In embodiments, during this process the merging engine 118 could be inactive (e.g., no merging would be occurring).

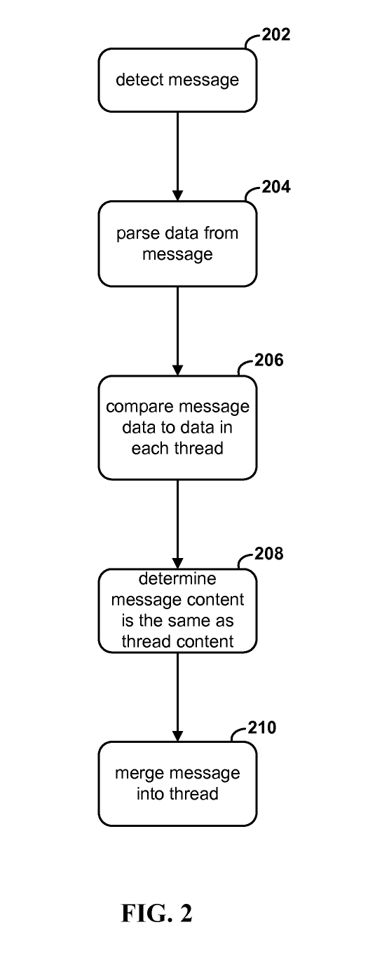

FIG. 2 depicts a flow diagram of a method for handling incoming messages, based on content, according to embodiments. A message may be detected at 202, for example, by the monitoring engine 114 of FIG. 1. This message could be, for example, an incoming email or instant message to a particular account. The system may then parse content data from the message, at 204. As described herein, data could be parsed by an NLP system, and the NLP system can be internal or external to the message handling system (for example, the message handling system 112 depicted in FIG. 1).

The system could then compare the content data from the message to the data in each thread, where each thread is associated with the particular account that received the new message, at 206. For example, the content data from the email message could be compared to content data of each of the threads already received and which may be queued in an inbox. Settings could provide for only unread messages to be included in the threads that are compared. In embodiments, other settings could specify that the content of the new message be compared with content of each message in the each of the plurality of threads, or the setting could specify that the content of the new message be compared with aggregate or categorized content for each of the threads, where the content for each of the messages in a particular thread is aggregated, assigned a category, or otherwise compiled to provide enough data to determine if the message is matching.

At 208, the system can determine if the new message content is the same as the content for a particular thread. “Sameness” could be determined by comparing a sameness value to a threshold value, as described herein. If the system determines that the content of the new message is the same as the content of a particular thread, then the message may be merged into the thread, per 210.

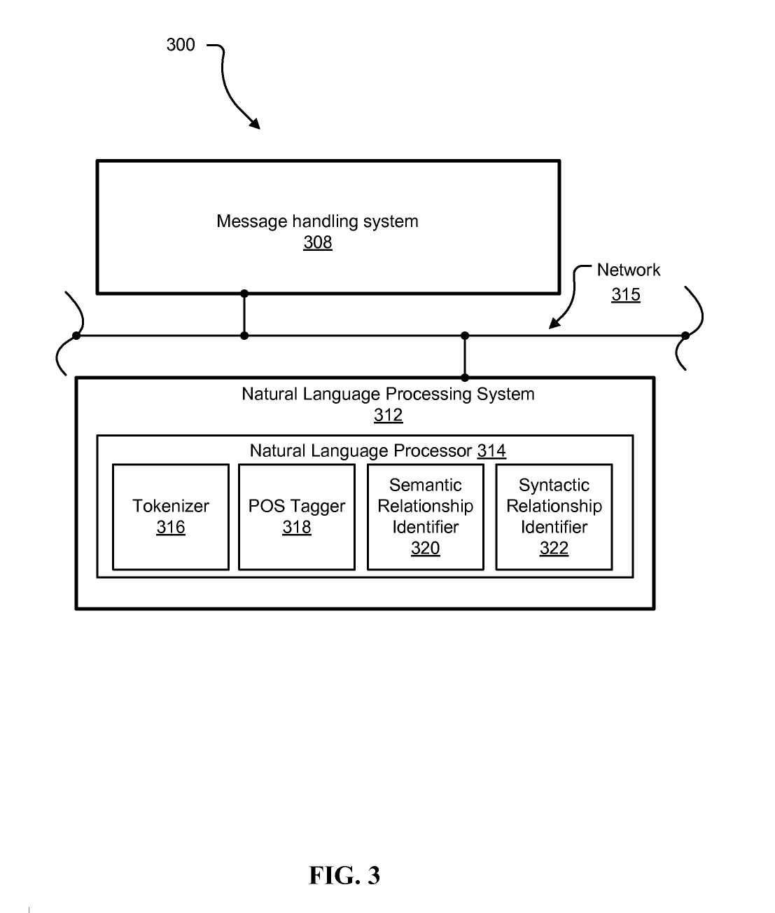

FIG. 3 depicts a block diagram of an example natural language processing system configured to parse content data from messages, consistent with embodiments. Aspects of FIG. 3 are directed toward an exemplary system 300, including a natural language processing system 312 to parse message data. In some embodiments, the message handling system (like the message handling system 112 of FIG. 1) may submit messages to be parsed for content data by the natural language processing system 312 which may be included in a host device. A remote device, like the message handling system 308, may send and receive messages to be parsed by the NLP system 312 over a network 315.

Consistent with various embodiments, natural language processing system 312 may respond to messages sent by message handling system 308. Specifically, natural language processing system 312 may parse content data from the messages, including subject, sender, tone, and other content-relevant data. In some embodiments, natural language processing system 312 may include a natural language processor 314. Natural language processor 314 may be a computer module that analyzes the received messages. Natural language processor 314 may perform various methods and techniques for analyzing messages (syntactic analysis, semantic analysis, etc.). The natural language processor 314 may be configured to recognize and analyze a variety of natural languages. Further, natural language processor 314 may include various modules to perform analyses of messages. These modules may encompass, but are not limited to, a tokenizer 316, part-of-speech (POS) tagger 318, semantic relationship identifier 320, and syntactic relationship identifier 322.

In some embodiments, tokenizer 316 may be a computer module that performs lexical analysis. Tokenizer 316 may convert a sequence of characters into a sequence of tokens. A token may be a string of characters included in a message and categorized as a meaningful symbol. Further, in some embodiments, tokenizer 316 may identify word boundaries in a message and break any text passages within the document into their component text elements, such as words, multiword tokens, numbers, and punctuation marks. In some embodiments, tokenizer 316 may receive a string of characters, identify the lexemes in the string, and categorize them into tokens.

Consistent with various embodiments, POS tagger 318 may be a computer module that marks up a word in messages to correspond to a particular part of speech. POS tagger 318 may read a message or other text in natural language and assign a part of speech to each word or other token. POS tagger 318 may determine the part of speech to which a word (or other text element) corresponds based on the definition of the word and the context of the word. The context of a word may be based on its relationship with adjacent and related words in a phrase, sentence, question, or paragraph. In some embodiments, the context of a word may be dependent on one or more previously analyzed messages (e.g., the content of one message may help to shed light on the meaning of another message). Examples of parts of speech that may be assigned to words include, but are not limited to, nouns, verbs, adjectives, adverbs, and the like. Examples of other part of speech categories that POS tagger 318 may assign include, but are not limited to, comparative or superlative adverbs, wh-adverbs, conjunctions, determiners, negative particles, possessive markers, prepositions, wh-pronouns, and the like. In some embodiments, POS tagger 318 may tag or otherwise annotate tokens of a message with part of speech categories. In some embodiments, POS tagger 318 may tag tokens or words of a message to be parsed by natural language processing system 312.

In some embodiments, semantic relationship identifier 320 may be a computer module that may identify semantic relationships of recognized text elements (e.g., words, phrases) in messages. In some embodiments, semantic relationship identifier 320 may determine functional dependencies between entities and other semantic relationships.

Consistent with various embodiments, syntactic relationship identifier 322 may be a computer module that may identify syntactic relationships in a message composed of tokens. Syntactic relationship identifier 322 may determine the grammatical structure of sentences, for example, which groups of words are associated as phrases and which word is the subject or object of a verb. Syntactic relationship identifier 322 may conform to formal grammar.

In some embodiments, natural language processor 314 may be a computer module that may parse content from a message. For example, in response to receiving a message at natural language processing system 312, natural language processor 314 may output parsed text elements from the message as data structures. In some embodiments, a parsed text element may be represented in the form of a parse tree or other graph structure. To generate the parsed text element, natural language processor 314 may trigger computer modules 316-322 to process the text, as described herein.

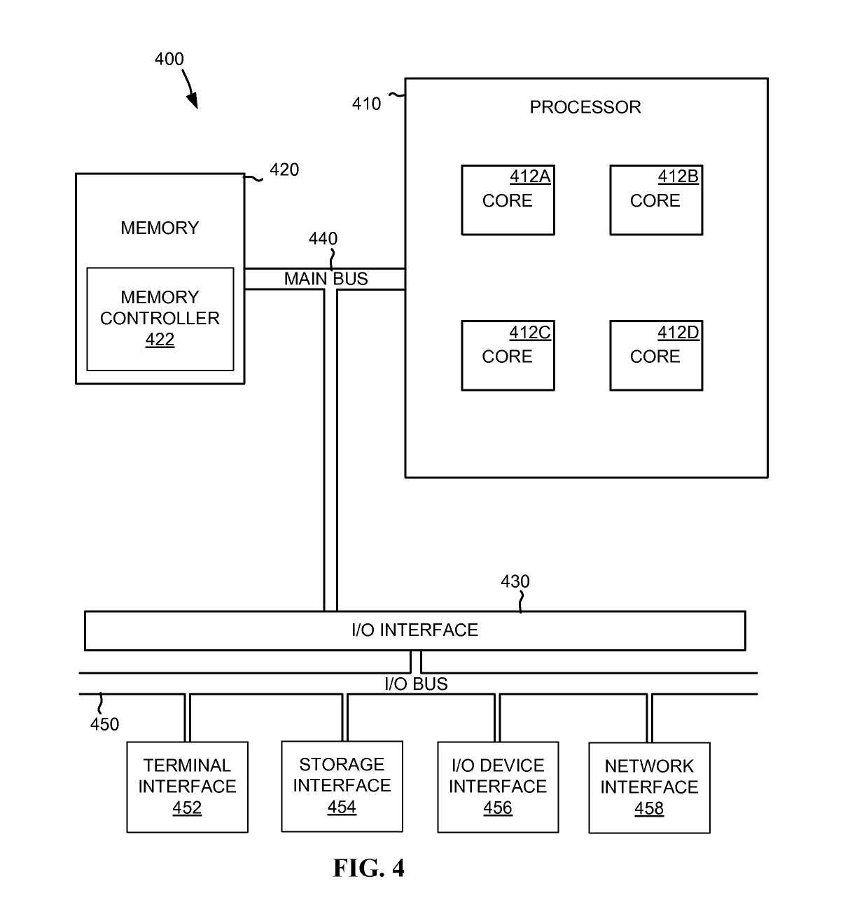

FIG. 4 depicts representative components of an example computer system 400 that may be used consistent with embodiments of the message handling system or elements thereof. Individual components may vary in complexity, number, type, and/or configuration. For example, computer system 400 may be a mobile device (e.g., tablet or phone), desktop or laptop computer, a network router or gateway, or a server. The particular embodiments disclosed are for example purposes only and are not necessarily the only variations. The computer system 400 may comprise a processor 410, memory 420, an input/output interface (herein I/O or I/O interface) 430, and a main bus 440. The main bus 440 may provide communication pathways for the other components of the computer system 400. In some embodiments, the main bus 440 may connect to other components such as a specialized digital signal processor (not depicted).

The processor 410 of the computer system 400 may be comprised of one or more cores 412A, 412B, 412C, and 412D (collectively 412). The processor 410 may additionally include one or more memory buffers or caches (not depicted) that provide temporary storage of instructions and data for the cores 412. The cores 412 may perform instructions on input provided from the caches or from the memory 420 and output the result to caches or the memory. The cores 412 may be comprised of one or more circuits configured to perform one or methods consistent with embodiments of the present disclosure. For example, cores 412 may contain modules that are configured to monitor for incoming messages, receive messages, send the messages to an NLP system, determine that the message matches a thread, and merge the message with the thread. In some embodiments, the computer system 400 may contain multiple processors 410. In some embodiments, the computer system 400 may be a single processor 410, which may have a singular core 412.

The memory 420 of the computer system 400 may include a memory controller 422. In some embodiments, the memory 420 may comprise a random-access semiconductor memory, storage device, or storage medium (either volatile or non-volatile) for storing data and programs. In some embodiments, the memory may be in the form of modules (e.g., dual in-line memory modules). Data pertaining to message threads relevant to a particular account, as well as data for a particular message, may be stored in the memory 420. The memory controller 422 may communicate with the processor 410, which may facilitate storage and retrieval of information in the memory 420. The memory controller 422 may communicate with the I/O interface 430, facilitating storage and retrieval of input or output in the memory 420.

The I/O interface 430 may comprise an I/O bus 450, a terminal interface 452, a storage interface 454, an I/O device interface 456, and a network interface 458. The I/O interface 430 may connect the main bus 440 to the I/O bus 450. The I/O interface 430 may direct instructions and data from the processor 410 and memory 420 to the various interfaces of the I/O bus 450. The I/O interface 430 may also direct instructions and data from the various interfaces of the I/O bus 450 to the processor 410 and memory 420. The various interfaces may include the terminal interface 452, the storage interface 454, the I/O device interface 456, and the network interface 458. In some embodiments, the various interfaces may include a subset of the aforementioned interfaces (e.g., an embedded computer system in an industrial application may not include the terminal interface 452 and the storage interface 454).

Hardware or software modules throughout the computer system 400—including but not limited to the memory 420, the processor 410, and the I/O interface 430—may communicate failures and changes to one or more components to a hypervisor or operating system (not depicted). The hypervisor or the operating system may allocate the various resources available in the computer system 400 and track the location of data in memory 420 and of processes assigned to various cores 412. In embodiments that combine or rearrange elements, aspects and capabilities of the logic modules may be combined or redistributed. These variations would be apparent to one skilled in the art.

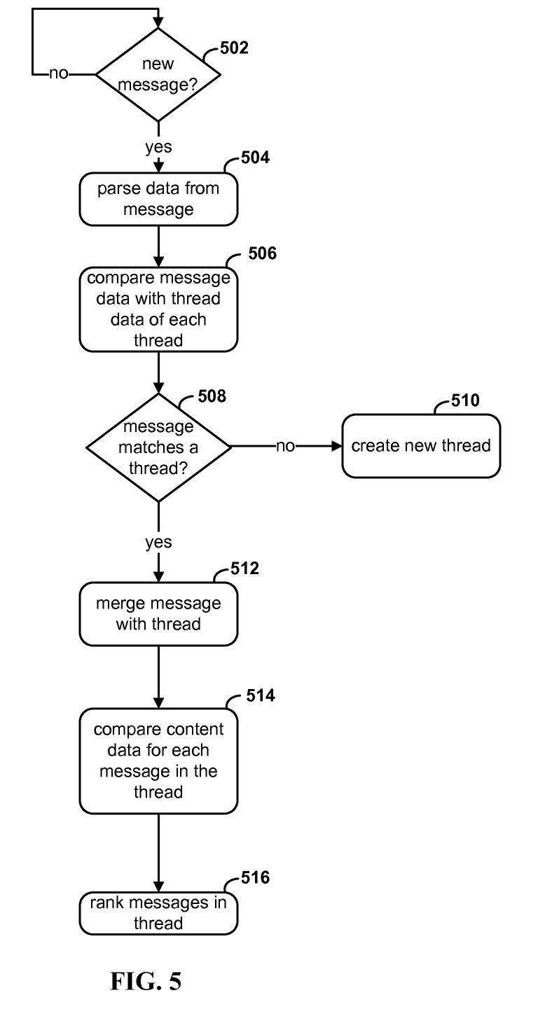

FIG. 5 depicts a flow diagram of a method for merging and sorting messages, consistent with embodiments. A message may be detected at 502 to initiate the message handling system processing a new message. If no message is detected, the system can continue to monitor for a message. Once the system has received a message, the system can parse data from the message, at 504. Content data may be parsed from the message by, for example, the use of an NLP system. The system may compare content data from the message with content data from each thread, where each of the threads are comprised of one or more messages whose data may have already been analyzed, at 506. At 508, the system may determine whether or not the content of the message is the same as the content of a thread in a plurality of threads that may be associated with a particular account (or user, etc.). If the message is determined not to be the same, then the system may create a new thread for that message, at 510. If, at 508, the system determines that the message is the same as a particular thread, based on for example a sameness value and a particular threshold, then the system may merge the message with the thread, at 512. In some embodiments, the system may further sort the messages, by ranking the messages within each particular thread. The system may then compare content data for each message in a particular thread with the content data of the other messages in the particular thread, at 514. Based on the comparison, the system can rank the messages in the thread, at 516. For example, the ranking could be determined by a number of factors, as determined by settings or in another way, as discussed herein.

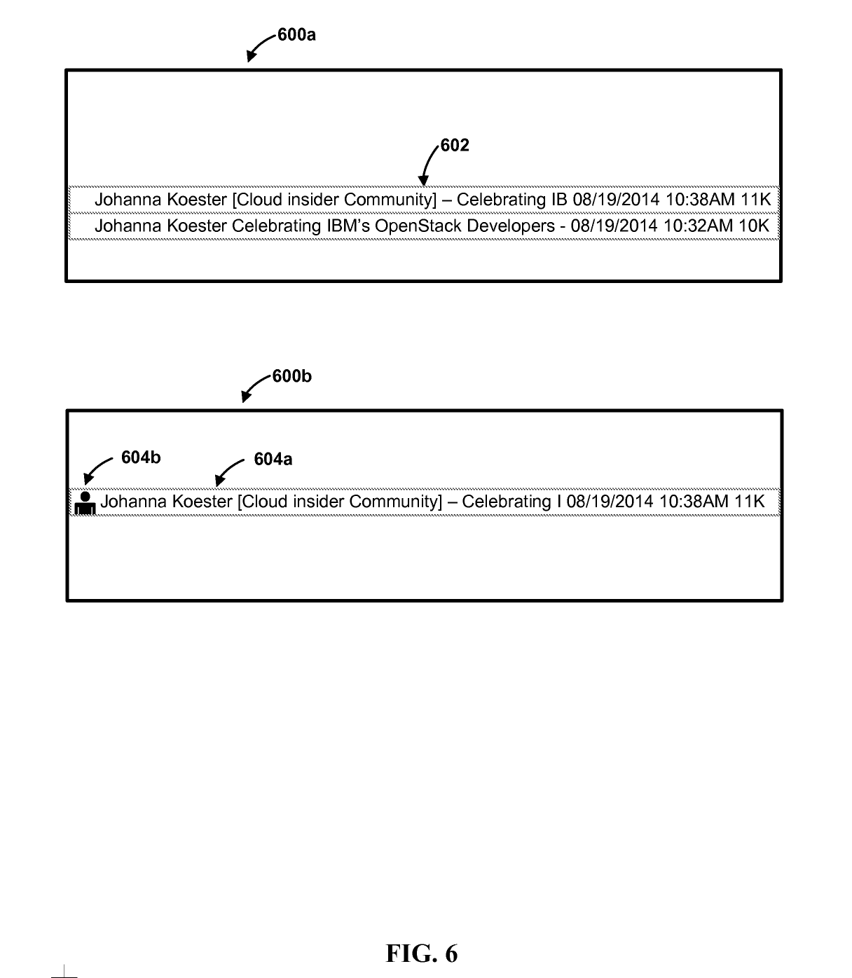

FIG. 6 depicts an example user interface 600 for displaying messages, consistent with embodiments. User interface 600a depicts a user interface on which sample messages 602 are displayed. For example, a display in the manner of 600a could be included within a portion of the display of a user's email inbox, and sample messages 602 may be views of two email messages received from a sender, for example Johanna Koester, as they might appear in an inbox. User interface 600b depicts a user interface on which sample messages 604 are displayed. Two particular emails may have the same content, and in an embodiment they may appear as two separate or individual messages. This could be because, for example, the subject or the sending user is different. For example, the messages displayed on user interface 600b could be the same as those displayed on 600a. Here, however, the system may identify the two messages as the same—based on, for example, a similarity threshold—and may merge the messages into a single thread. Thus the two messages can be displayed as one at 604, with 604a indicating message data like the sender, subject, and size. The icon at 604b may indicate—based on size, color, shape, or another attribute—that a plurality of messages have been received that have the same content as the message displayed to the user. Thus, rather than a system displaying the two separate lines of text, as in 600a, a system in the manner of an embodiment may display the messages with the same content as a single line of text, as in 600b.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for handling messages from a set of social data sources, the method comprising:
detecting from the set of social data sources, a new message;
parsing, from the new message, content data, the content data being data relevant to content of the new message;
comparing the content data of the new message with content data of each of a plurality of threads, each thread in the plurality of threads comprising one or more messages;
determining the content of the new message is the same as content of a first thread in the plurality of threads based on the comparing the content data of the new message with the content data of the plurality of threads; and
merging, with the first thread in the plurality of threads, the new message.

2. The method of claim 1, wherein the comparing further comprises calculating a sameness value for each of the plurality of threads, and the determining further comprises determining a calculated sameness value corresponding to the first thread in the plurality of threads exceeds a threshold value.

3. The method of claim 1, further comprising:
detecting, from the set of social data sources, a second new message;
parsing, from the second new message, second content data, the second content data being data relevant to content of the second new message;
comparing the second content data of the second new message with the content data of the plurality of threads;
determining, based on the comparing, the second content of the second new message is not the same as the content of one of the plurality of threads; and
creating, in response to the determining, a new thread, the new thread comprising the second new message.

4. The method of claim 1, wherein the new message is an email message.

5. The method of claim 1, wherein the content data comprises data about the tone, subject, images, and origin of the new message.

6. The method of claim 1, wherein the parsing, from the new message, content data, comprises:
sending, to a natural language processing (NLP) system, the new message; and
receiving, from the NLP system, the content data of the new message, the content data of the new message including a subject and a tone of the new message.

7. The method of claim 1, further comprising:
ranking, responsive to the merging the new message, each message of the messages in the one of the plurality of threads, the ranking based on popularity; and
displaying, responsive to the ranking, the messages in the one of the plurality of threads, according to the ranking.

8. A system for handling messages from a set of social data sources, the system comprising:
a computing device comprising a computer readable medium with program instructions stored thereon and one or more processors configured to execute the program instructions to perform a method comprising:
detecting from the set of social data sources, a new message;
parsing, from the new message, content data, the content data being data relevant to content of the new message;
comparing the content data of the new message with content data of each of a plurality of threads, each thread in the plurality of threads comprising one or more messages;
determining the content of the new message is the same as content of a first thread in the plurality of threads based on the comparing the content data of the new message with the content data of the plurality of threads; and
merging, with the first thread in the plurality of threads, the new message.

9. The system of claim 8, wherein the comparing further comprises calculating a sameness value for each of the plurality of threads, and the determining further comprises determining a calculated sameness value corresponding to the first thread in the plurality of threads exceeds a threshold value.

10. The system of claim 8, wherein the method further comprises:
detecting, from the set of social data sources, a second new message;
parsing, from the second new message, second content data, the second content data being data relevant to content of the second new message;
comparing the second content data of the second new message with the content data of the plurality of threads;
determining, based on the comparing, the second content of the second new message is not the same as the content of one of the plurality of threads; and
creating, in response to the determining, a new thread, the new thread comprising the second new message.

11. The system of claim 8, wherein the new message is an email message.

12. The system of claim 8, wherein the content data comprises data about the tone, subject, images, and origin of the new message.

13. The system of claim 8, wherein the parsing, from the new message, content data, comprises:
sending, to a natural language processing (NLP) system, the new message; and
receiving, from the NLP system, the content data of the new message, the content data of the new message including a subject and a tone of the new message.

14. The system of claim 8, wherein the method further comprises:
ranking, responsive to the merging the new message, each message of the messages in the one of the plurality of threads, the ranking based on popularity; and
displaying, responsive to the ranking, the messages in the one of the plurality of threads, according to the ranking.

15. A computer program product for handling messages from a set of social data sources, the computer program product comprising a computer readable storage medium having program instructions embodied therewith, wherein the computer readable storage medium is not a transitory signal per se, the program instructions executable by a computer processor to cause the processor to perform a method comprising:
detecting from the set of social data sources, a new message;
parsing, from the new message, content data, the content data being data relevant to content of the new message;
comparing the content data of the new message with content data of each of a plurality of threads, each thread in the plurality of threads comprising one or more messages;
determining the content of the new message is the same as content of a first thread in the plurality of threads based on the comparing the content data of the new message with the content data of the plurality of threads; and
merging, with the first thread in the plurality of threads, the new message.

16. The computer program product of claim 15, wherein the comparing further comprises calculating a sameness value for each of the plurality of threads, and the determining further comprises determining a calculated sameness value corresponding to the first thread in the plurality of threads exceeds a threshold value.

17. The computer program product of claim 15, wherein the method further comprises:
detecting, from the set of social data sources, a second new message;
parsing, from the second new message, second content data, the second content data being data relevant to content of the second new message;
comparing the second content data of the second new message with the content data of the plurality of threads;
determining, based on the comparing, the second content of the second new message is not the same as the content of one of the plurality of threads; and
creating, in response to the determining, a new thread, the new thread comprising the second new message.

18. The computer program product of claim 15, wherein the content data comprises data about the tone, subject, images, and origin of the new message.

19. The computer program product of claim 15, wherein the parsing, from the new message, content data, comprises:
sending, to a natural language processing (NLP) system, the new message; and
receiving, from the NLP system, the content data of the new message, the content data of the new message including a subject and a tone of the new message.

20. The computer program product of claim 15, wherein the method further comprises:
ranking, responsive to the merging the new message, each message of the messages in the one of the plurality of threads, the ranking based on popularity; and
displaying, responsive to the ranking, the messages in the one of the plurality of threads, according to the ranking.
